(19) United States
(12) Patent Application Publication
(10) Pub. No.: US 2023/0422030 A1
(43) Pub. Date: Dec. 28, 2023

(54) Trustful Service Traffic Handling in a Core Network Domain

(71) Applicant: Telefonaktiebolaget LM Ericsson (publ), Stockholm (SE)

(72) Inventors: Alfonso de Jesus Perez Martinez, Madrid (ES); Miguel Angel Muñoz De La Torre Alonso, Madrid (ES); Rodrigo Alvarez Dominguez, Madrid (ES)

(21) Appl. No.: 18/039,078

(22) PCT Filed: Jan. 27, 2021
(86) PCT No.: PCT/EP2021/051807

§ 371 Date: May 26, 2023

(30) Foreign Application Priority Data
Dec. 21, 2020 (EP) 20383129.2

(51) Int. Cl. H04W 12/033; H04W 12/08; G06Q 20/32; G06Q 20/02; H04M 15/00

(52) U.S. Cl. CPC H04W 12/033; H04W 12/08; G06Q 20/325; G06Q 20/02; H04M 15/59

(57) ABSTRACT

A technique of configuring a core network domain of a wireless communication network for detection of service traffic that is to be trustfully handled in accordance with traffic handling information stored in a blockchain is provided. A method implementation of this technique comprises receiving, from a service provider, traffic detection information for service traffic that is to be handled in accordance with the traffic handling information. The method further comprises triggering an association, in the blockchain, of the received traffic detection information with the traffic handling information, and providing the traffic detection information to the core network domain for detecting the service traffic that is to be handled in accordance with the traffic handling information.

### TECHNICAL FIELD

The present disclosure generally relates to wireless communication. In more detail, aspects in the context of trustfully handling service traffic in a core network domain of a wireless communication network based on traffic handling information stored in a blockchain are presented. These aspects can be implemented as methods, computer program products, devices and systems.

### BACKGROUND

Currently, more and more network traffic is being encrypted as users and businesses attempt to keep their data private and secure as it travels through the Internet and other networks. By encrypting transmissions, sensitive information, such as a user's login ID for an online banking session, or a credit card number, is protected and kept out of the hands of potential hackers and criminal organizations.

Due to traffic encryption, operators of wireless communication networks, with their network security and traffic monitoring tools, cannot simply identify the services that generate the traffic routed through their networks. Service type identification is, however, important to ensure proper traffic handling in a core network domain. As an example, traffic of certain service types (e.g., audio or video streaming) may need to be handled with higher Quality of Service (QoS) in the core network domain than traffic of other service types (e.g., online banking). As another example, different volume-based tariffs may need to be applied to traffic of different service types.

It would thus generally be desirable to reliably detect, in the core network domain, service traffic provided by a certain service provider (e.g., a dedicated Internet-based application service) to a service consumer (e.g., a terminal device operated by a particular subscriber). Of course, it would further be desirable that the service consumer, the service provider as well as the network operator have trust in each other that traffic of a particular service is correctly provided, detected and handled in accordance with, for example, pre-agreed conditions.

At present, network operators, with their traffic monitoring tools, attempt to guess service types based on general service traffic characteristics (such as dedicated traffic patterns, digital signatures, Service Name Indication (SNI) query names, traffic metrics, and traffic statistics), but identification accuracy is not guaranteed to be 100%. As a further challenge, Internet applications change almost constantly. There are new tendencies, fashions, websites evolving rapidly. Moreover, server pools, Internet Protocol (IP) addresses, ports, and so on are changing daily due to traffic expansion, redundancy or routing through virtual cloud networks. Detecting encrypted service traffic based on general service traffic characteristics thus becomes even more inefficient and error prone.

Partly due to the uncertainties associated with a reliable identification of service traffic in wireless communication networks, subscribers do not have satisfactory visibility in regard to consumed traffic volume, applied tariff type or charged service duration. That is, when subscribers launch services (e.g., applications) on their terminal devices that lead to service traffic being routed through an operator's core network domain, it is not clear exactly how much volume will be charged, how much volume will be consumed, which tariff type will be applied, and so on.

Traffic encryption between, for example, an application server and a terminal device is governed by cryptographic protocols such as the Transport Layer Security (TLS) protocol. Some tools in the core network domain provide TLS decryption technology for decrypting the service traffic so as to detect the service type associated with the service traffic. Such tools can be considered as Man in the Middle (MITM) implementations and, as such, are particularly vulnerable to security and confidential issues since traffic can be inspected in clear text and may leak confidential information to external parties. In this case, TLS is losing its central security advantages.

### SUMMARY

Accordingly, there is a need for a technique that avoids one more of the above drawbacks and enables a secure and trustful handling of service traffic in a core network domain.

According to a first aspect, a method of configuring a core network domain of a wireless communication network for detection of service traffic that is to be trustfully handled in accordance with traffic handling information stored in a blockchain is provided. The method comprising receiving, from a service provider, traffic detection information for service traffic that is to be handled in accordance with the traffic handling information. The method further comprises triggering an association, in the blockchain, of the received traffic detection information with the traffic handling information, and providing the traffic detection information to the core network domain for detecting the service traffic that is to be handled in accordance with the traffic handling information.

The traffic detection information may be received responsive to a service-related request having been triggered by a service consumer. The service consumer may be a terminal device or an application installed thereon. As an example, the service-related request may be received from the service consumer. In such a case, the method may further comprise triggering storing of the service-related request, or of information contained therein, as a dedicated event in the blockchain (e.g., as a dedicated blockchain transaction, optionally in a dedicated data block).

The method may further comprise forwarding the service-related request, or information contained therein, to the service provider. In such a forwarding scenario, the traffic detection information may be received as a response to the forwarding of the service-related request, or of the information contained therein, to the service provider.

The service provider may be an application server or an application installed thereon. In some variants, the service may be an Over-The-Top (OTT) service. The OTT service may be a streaming or messaging service.

The method may further comprise forwarding the service-related request, or information contained therein, to the core network domain. As an example, the service-related request, or information contained therein, may be forwarded to a network node or network function that constitutes an entry point into the core network domain. In such an implementation, the method may fully or partially be performed outside the core network domain. The method may further comprise receiving, as a response from the core network domain, a detection information request. In such an implementation, the traffic detection information may be provided to the core network do-main responsive to the detection information request.

Forwarding of the service-related request to the service provider and the core network domain as well as the responses from the service provider and the core network domain may belong to a selective endorsement procedure. As understood herein, a selective endorsement procedure is a consensus algorithm among some or all of the individual members, or participants, (e.g., domains of trust) of a selective endorsement group. Such members typically include the service provider, the service consumer, and the operator of the wireless (e.g., mobile) communication network with the core network domain.

The received traffic detection information may selectively permanently be associated in the blockchain with the traffic handling information (e.g., as a dedicated blockchain transaction, for example in a dedicated data block) if the selective endorsement procedure was successful. Success of the selective endorsement procedure may be detected when the individual participants have all given their consent to blockchain content (e.g., a blockchain transaction) on which consensus has to be achieved, which may involve their electronic signatures being applied. If, on the other hand, the selective endorsement procedure has failed (e.g., because at least one participant has not consented to a particular blockchain transaction), the received traffic detection information is not permanently associated in the blockchain with the traffic handling information.

Triggering, in the blockchain, an association of the received traffic detection information with the traffic handling information may comprise triggering storing of the traffic detection information in a data block of the blockchain (e.g., as a dedicated blockchain transaction). In some variants, the traffic handling information is stored in the same or in another data block of the blockchain.

The method may comprise triggering appending of the data block that stores the traffic detection to the other data block that stores the traffic handling information. The other data block that stores the traffic handling information may be a genesis data block of the blockchain. A dedicated genesis data block may be created for each service invocation by the service consumer.

The method may comprise detecting a particular event related to a service associated with the service traffic. The particular event may be selected from a set of event types comprising: service creation, service start, service termination, and service modification. The method may then further comprise triggering, for each detected event, creation at least one of a dedicated transaction and a dedicated data block in the blockchain. Furthermore, a selective endorsement procedure may be triggered for each dedicated transaction or each dedicated data block.

Triggering the selective endorsement procedure for a given transaction or a given data block may comprise sending transaction information to be stored in the blockchain to two or more members of a selective endorsement group comprising the service provider, the service consumer, and the operator of the wireless communication network.

The blockchain may be a private blockchain among the service provider, the service consumer, and the operator of the wireless communication network. In particular, the private blockchain may be restricted to a predefined group of members, or participants.

The traffic handling information may relates to one or more of: Quality-of-Service, QoS, handling of the service traffic; billing of the service traffic; a predefined service traffic volume; penalization handling; and service duration. Penalization handling may refer to actions performed when a predefined threshold (e.g., in regard to a traffic volume, traffic duration, etc.) is reached or exceeded. Those actions may include charging actions, bandwidth limiting actions, and so on.

The traffic handling information may be encoded in the blockchain in the form of a smart contract. The smart contract may in particular be encoded in a genesis data block of the blockchain.

The traffic to be detected in the core network domain may be end-to-end encrypted between the service provider and the service consumer. The encryption may be governed by a transport layer protocol such as TLS.

The traffic detection information may identify at least one packet flow transporting the service traffic. The traffic detection information may comprises one or more of the following: information permitting identification of a packet flow transporting the service traffic (e.g., an N-tuple, in particular a 5-tuple); a Universal Resource Identifier (URI); one or more of a domain name, a Domain Name System (DNS) query name, and a Service Name Indication (SNI), query name; and a transport layer protocol.

The method of the first aspect may be performed outside the core network domain. In particular, the method may be performed on a dedicated network node. The network node may also host the blockchain or may have access to the blockchain if the latter is hosted on another network node or in a cloud computing environment.

According to a second aspect, a method of configuring a blockchain for enabling trustful handling of service traffic in a core network domain of a wireless communication network in accordance with traffic handling information stored in a blockchain is provided, wherein a selective endorsement procedure is used to achieve consensus on blockchain contents. The method is performed in a service provider domain and comprises receiving a service-related request including service information that at to least identifies a service consumer of a service for which the service traffic is to be detected in the core network domain. The method further comprises verifying, as part of the selective endorsement procedure, at least a part of the service information and determining, based at least on a part of the service information, traffic detection information that enables detection of the service traffic when routed through the core network domain. The method further comprises returning the traffic detection information with an indication of a result of the verification so as to control an association, in the blockchain, of the traffic detection information with the traffic handling information.

The service information may further identify at least one of the service, an event related to the service, and the blockchain (e.g., using a dedicated blockchain identifier). The indication of the result of the verification may take the form of a signature applied in the service provider domain (e.g., by an application server) as a dedicated domain of trust.

According to a third aspect, a method of configuring a core network domain of a wireless communication network for detection of service traffic that is to be trustfully handled in accordance with traffic handling information stored in a blockchain is provided, wherein a selective endorsement procedure is used to achieve consensus on blockchain contents. The method is performed in the core network domain and comprises receiving a service-related request including service information which at least identifies a service consumer of a service for which the service traffic is to be detected in the core network domain. The method further comprises verifying, as part of the selective endorsement procedure, at least a part of the service information and returning an indication of a result of the verification so as to control an association, in the blockchain, of traffic detection information with the traffic handling information, wherein the traffic detection information enables detection of the service traffic when routed through the core network domain. Further still, the method comprises receiving the traffic detection information.

The service information may further identify at least one of the service, an event related to the service, and the blockchain. The indication of the result of the verification may take the form of a signature applied in the core network domain (as a dedicated domain of trust).

The method of the third aspect may comprise sending a request for the traffic detection information. In such an implementation, the traffic detection information is received in response to the request.

The method of the third aspect may also comprise forwarding the traffic detection information, or a traffic detection rule derived therefrom, towards a user plane entity in the core network domain. The user plane entity may be configured to intercept user plane traffic and detect the service traffic.

The method of the third aspect may further comprise obtaining traffic handling information for the service traffic, and applying the traffic handling information to the service traffic detected using the traffic detection information.

According to a fourth aspect, a method of configuring a core network domain of a wireless communication network for trustful handling of service traffic in accordance with traffic handling information stored in a blockchain is provided, wherein a selective endorsement procedure is used to achieve consensus on blockchain contents.

The method is performed in a service consumer domain and comprises receiving a message containing traffic handling information, wherein the traffic handling information controls handling of the service traffic when routed through the core network domain. The method further comprises verifying, as part of the selective endorsement procedure, the traffic handling information and returning an indication of a result of the verification so as to control a storing, in the blockchain, of the traffic handling information.

The traffic handling information may be encoded in a smart contract. The smart contract may be encoded in a genesis data block of the blockchain.

The indication of the result of the verification may take the form of a signature applied in the service consumer domain (e.g., on a terminal device that constitutes the service consumer or on which the service consumer is running).

Also provided is a computer program product comprising program code portions that, when executed on at least one processor, configure the processor to perform the method of any of the preceding aspects. The computer program product may be stored on a computer-readable recording medium or may be encoded in a data signal.

Further, a first device for configuring a core network domain of a wireless communication network for detection of service traffic that is to be trustfully handled in accordance with traffic handling information stored in a blockchain is provided. The device is configured to receive, from a service provider, traffic detection information for service traffic that is to be handled in accordance with the traffic handling information, and to trigger an association, in the blockchain, of the received traffic detection information with the traffic handling information. The device is further configured to provide the traffic detection information to the core network domain for detecting the service traffic that is to be handled in accordance with the traffic handling information.

The first device discussed above may be configured to perform the method of the first method aspect.

Further still, a second device for configuring a blockchain for enabling trustful handling of service traffic in a core network domain of a wireless communication network in ac-accordance with traffic handling information stored in a blockchain is provided, wherein a selective endorsement procedure is used to achieve consensus on blockchain contents. The device is a service provider device and configured to receive a service-related request including service information that at least identifies a service consumer of a service for which the service traffic is to be detected in the core network domain. The device is also configured to verify, as part of the selective endorsement procedure, at least a part of the service information, to determine, based at least on a part of the service information, traffic detection information that enables detection of the service traffic when routed through the core network domain, and to return the traffic detection information with an indication of a result of the verification so as to control an association, in the blockchain, of the traffic detection information with the traffic handling information.

The second device discussed above may be configured to perform the method of the second method aspect.

Also provided is a third device for configuring a core network domain of a wireless communication network for detection of service traffic that is to be trustfully handled in accordance with traffic handling information stored in a blockchain, wherein a selective endorsement procedure is used to achieve consensus on blockchain contents. The device is a core network device and configured to receive a service-related request including service information that at least identifies a service consumer of a service for which the service traffic is to be detected in the core network domain. The device is further configured to verify, as part of the selective endorsement procedure, at least a part of the service information, and to return an indication of a result of the verification so as to control an association, in the blockchain, of traffic detection information with the traffic handling information, wherein the traffic detection information enables detection of the service traffic when routed through the core network domain. Moreover, the device is configured to receive the traffic detection information.

The third device discussed above may be configured to perform the method of the third method aspect.

Additionally presented is a fourth device for configuring a core network domain of a wireless communication network for trustful handling of service traffic in accordance with traffic handling information stored in a blockchain, wherein a selective endorsement procedure is used to achieve consensus on blockchain contents. The device is a service consumer device and configured to receive a message containing traffic handling information, wherein the traffic handling information controls handling of the service traffic when routed through the core network domain. The device is also configured to verify, as part of the selective endorsement procedure, the traffic handling information and to return an indication of a result of the verification so as to control a storing, in the blockchain, of the traffic handling information.

The fourth device discussed above may be configured to perform the method of the fourth method aspect.

A system as presented herein comprises at least two of the four devices discussed above.

### BRIEF DESCRIPTION OF THE DRAWINGS

Further aspects, details and advantages of the present disclosure will become apparent from the detailed description of exemplary embodiments below and from the drawings, wherein:

FIG. 1 is a diagram illustrating a network system embodiment of the present disclosure;

FIG. 2 is a block diagram illustrating apparatus embodiments of the present disclosure;

FIG. 3 is a diagram illustrating an exemplary 5G network architecture that can form the basis of embodiments of the present disclosure; and

FIGS. 4 to 7 are schematic diagram signalling diagrams illustrating further embodiments of the present disclosure in the context of the 5G network architecture of FIG. 3;

FIG. 8 is a schematic diagram illustrating a blockchain embodiment of the present disclosure; and

FIGS. 9 to 12 illustrate flow diagrams of four method embodiments of the present disclosure.

### DETAILED DESCRIPTION

In the following description, for purposes of explanation and not limitation, specific details are set forth in order to provide a thorough understanding of the present disclosure. It will be apparent to one skilled in the art that the present disclosure may be practiced in other embodiments that depart from these specific details.

While, for example, the following description focuses on an exemplary core network configuration in accordance with 5G specifications, the present disclosure is not limited in this regard. The present disclosure could, for example, also be implemented in other cellular or non-cellular wireless communication networks having a core network domain, such as those complying with 4G specifications (e.g., in accordance with the Long Term Evolution, LTE, specifications as standardized by the 3 rd Generation Partnership Project, 3GPP).

Those skilled in the art will further appreciate that the steps, services and functions explained herein may be implemented using individual hardware circuits, using software functioning in conjunction with a programmed microprocessor or general purpose computer, using one or more application specific integrated circuits (ASICs) and/or using one or more digital signal processors (DSP). It will also be appreciated that when the present disclosure is described in terms of a method, it may also be embodied in one or more processors and one or more memories coupled to the one or more processors, wherein the one or more memories store one or more computer programs that perform the steps, services and functions disclosed herein when executed by one or more processors.

In the following description of exemplary embodiments, the same reference numerals denote the same or similar components.

This following embodiments provide a technique for reliably detecting unencrypted or, in particular, encrypted service traffic in a core network domain so as to trustfully enforce a traffic handling action in regard to the service traffic (such as charging or QoS handling) under agreement of all parties involved: operator of a wireless communication network with a core network domain, subscriber with a terminal device acting as service consumer and an Over-The-Top (OTT) or other external entity operating a server, application, etc. acting as service provider. In case of encrypted service traffic, the traffic content will not be compromised since it must not be decrypted and, thus, does not become visible to network operator.

Some embodiments integrate an (e.g., permissioned) private blockchain in the network architecture and, thus, add an extra access-control layer in a blockchain domain. A blockchain provides a data structure in which trusted information is grouped into data blocks. Meta-information is added to each data block relative to a neighbouring data block of the chain in a linear timeline, so that thanks to cryptographic techniques, the information contained in a data block can only be repudiated or edited by modifying other blocks.

In the embodiments, the blockchain will contain traffic detecting information (e.g., one or more of IP addresses, ports, digital signatures, certificates) about how to detect encrypted traffic associated with a particular service, but will never compromise the content of this service as such. The core network domain can reliably detect the encrypted traffic thanks to this information (that is trustfully stored in the blockchain).

Data blocks in the blockchain are generated by establishing consent in regard to their content among the involved entities: network operator, subscriber and service providing entity. A first data block of a new blockchain preferably is generated in the moment that a service is launched. Further data blocks may record event records about the service, thus avoiding that the network operator needs to understand how service protocol works. For example, if the service is a voice IP messenger, the service provider can add information events about a particular voice call (new members joined/left, call start, call end) in order to enable the network operator to apply different policies to this service (e.g., increase/reduce bandwidth thresholds, change charging dependent on number of members in the call, etc.). The network operator will never need to understand the service protocol because these events may apply to any policy function. The network operator may also include in these data blocks information gathered in the core network domain about the service, such as the exact consumed volume of the service, duration of service, number of service consumers, tariff applied, and so on. Both the subscribers and the service provider entities can verify this information by reading the associated data blocks.

The history of a service instantiation and service-related meta-information (e.g., relating to one or more of charging, data volume consumed, service duration, number of service consumers, etc.) can thus be recorded in a blockchain to by verified by any party involved. The blockchain technology is especially suitable for such service-related scenarios in which increasingly ordered data is required to be stored over time, without the possibility of modification or revision and whose trust is intended to be distributed instead of residing in a certifying entity.

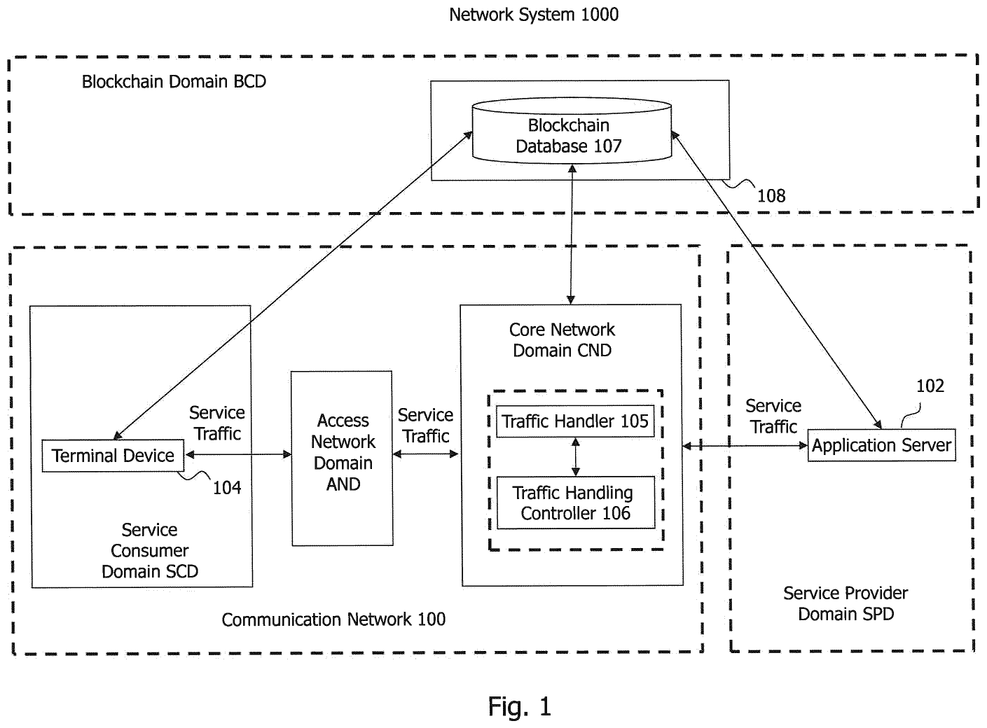

FIG. 1 illustrates an embodiment of a network system 1000 in which the present disclosure can be implemented.

As shown in FIG. 1, the network system 1000 comprises a communication network 100 operated by a network operator. The communication network 100 may be a wireless (e.g., a mobile) communication network. As shown in FIG. 1, the communication system 100 comprises a core network domain CND and an access network domain AND. In some realizations, each of these domains comprises a user plane for transporting service traffic and a control plane for transporting control signaling.

The network system 1000 further comprises a service provider domain SPD with a service provider in the form of an application server 102 (e.g., an Internet-based server offering audio or video streaming services) and a service consumer domain SCD (as part of the communication network 100) with a service consumer in the form of a terminal device 104. The terminal device 104 can be a user equipment(UE-) type device (e.g., a smartphone) or an Internet of Things-(IoT-) type device (e.g., a car and a wearable device). The terminal device 104 is connected to the application server 102 via the access network domain AND (e.g., an access point or a base station) and the core network domain CND.

The access network domain AND and the core network domain CND are configured to transport service traffic between the service provider domain SPD and the service consumer domain SCD. Additionally, the core network domain CND is configured for service traffic handling, for example to optimize, control or charge the service traffic. An exemplary service traffic optimization may reduce the bandwidth consumed by the service traffic to be transported through the access network domain AND.

The service traffic will primarily be generated in the service provider domain SPD. It will be appreciated that the terminal device 104 could likewise function as a sender of service traffic (e.g., when uploading video or audio data on a streaming platform). In some variants, the service traffic is generated by an OTT application (such as YouTube, Netflix, Spotify or Deezer). Such an OTT application generates OTT service traffic that take the form of one or more OTT data flows.

The core network domain CND comprises multiple network entities. In FIG. 1, primarily the network entities participating in service traffic handling are illustrated. Those network entities comprise a traffic handler 105 and a traffic handling controller 106. The traffic handler 105 and the traffic handling controller 106 may be implemented as separate core network entities or integrated into one single core network entity (as illustrated in FIG. 1 by a dashed box). The traffic handling controller 106 is configured to enable the triggering of a traffic handling action (e.g., application of a traffic handling rule) by the traffic handler 105. The traffic handling action may be performed in a session context.

As shown in FIG. 1, the network system 1000 further comprises a blockchain domain BCD with a blockchain database 107. The blockchain database 107 is hosted on a dedicated network node 108 in the blockchain domain BCD. In other variants, the blockchain database 107 is external to, but accessible by the network node 108. The network node 108 is configured to be communicatively coupled to each of the service consumer domain SCD (e.g., to the terminal device 104), the service provider domain SPD (e.g., to the application server 102) and the core network domain CND (e.g., to a dedicated network node acting as an entry point into the core network domain CND).

The blockchain database 107 is configured to store individual blockchains. In particular, a dedicated blockchain may be created for each launch (i.e., instantiation) of a particular service.

A blockchain is a set of (typically time-stamped) transaction records stored in data blocks that are linked to each other using cryptographic principles (e.g., using hash operations). In the context of certain embodiments, each blockchain in the blockchain database 107 is configured as a permissioned private blockchain among the members of a selective endorsement group. Each such group will typically include, as separate domains of trust, a dedicated service provisioning entity (operating the service provider such as the application server 102), a dedicated subscriber (operating the service consumer such as the terminal device 104), and a dedicated network operator (operating the core network domain CND of the communication network 100). The blockchain concept permits handling of service traffic by the traffic handler 105 in accordance with traffic detection and traffic handling information trustfully stored in one or more data blocks of a blockchain.

Each blockchain stored in the blockchain database 107 is private for several reasons. First, in a private blockchain, only the entities participating in a dedicated blockchain transaction will have knowledge about it, whereas other entities (e.g., other subscribers or OTT entities than those involved in a dedicated service instantiation) will not be able to access the blockchain. So a private blockchain is restricted to entities in the network system 1000 that actually participate in a specific service context, which facilitates security, anonymity, and trust.

Second, a private blockchain is also faster than a public blockchain. In a private blockchain, consensus is usually achieved through a procedure called selective endorsement. It is based on the concept that members of a selective endorsement group have gained permission to participate, and that the members involved in a blockchain transaction are able to confirm it. The advantage is that a blockchain using this type of consensus can be built with a more modular architecture, and it can allow for greater transaction volume at faster speeds. Consensus algorithms such as Proof of Elapsed Time (PoET), Raft, and Istanbul BFT can mainly be used in case of private blockchains. Selective endorsement does not require anywhere near the amount of computational resources that Proof of Work (or similar consensus algorithms for public blockchains) does, so a private blockchain can process much higher transaction volumes at higher speeds with far fewer computational resources. Ultimately, if consensus is automated and a scalable input and output system with lots of memory, a large cache and a fast commercial microprocessor is provided in the blockchain domain BCD, a private blockchain is capable of delivering and processing high volumes of data. This property is especially relevant in the present service context since service-related events need to be generated, processed and stored with low delay in the blockchain domain BCD.

Third, a private blockchain it is lighter than public blockchain. Since the number of authorized participants is less in a private blockchain, it can process hundreds or even thousands of transactions per second.

The blockchain database 107 is available for any service consumer (i.e., terminal device 104) by self-registration using public key cryptography. In some implementations, the service consumer creates a first data block of a new blockchain under supervision/agreement of the service provider and the operator of the communication network 100. These three entities verify the validity of transaction records in each data block and, if consensus is reached, consider it valid (for being stored permanently in the blockchain). This approach prevents tampering with the transaction records in the data blocks. The data blocks of each blockchain will only be accessible from that moment for these three parties: user/creator (typically the service consumer), service provider and operator of the communication network 100.

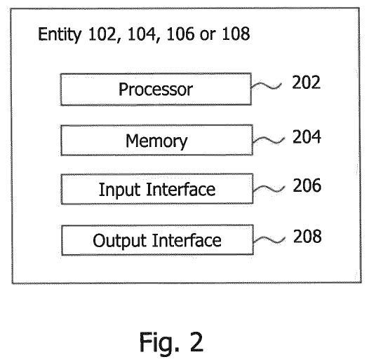

In the following, an embodiment illustrating a possible configuration of each of the application server 102, the terminal device 104, the traffic handling controller 106, and the network node 108 in the blockchain domain BCD will be discussed with reference to FIG. 2. As illustrated in FIG. 2, in one possible hardware implementation each of the devices 102, 104, 106 and 108 comprises a processor 202 and a memory 204 coupled to the processor 202. The memory 204 stores program code that controls operation of the processor 202. In the case of the network node 108 in the blockchain domain BCD, the memory 204 may further locally store the blockchain database 107. As understood herein, a processor, such as the processor 202, may be implemented using any processing circuitry and is not limited to, for example, a single processing core but may, for example, also have a distributed topology.

Each of the devices 102, 104, 106 and 108 further comprises an optional input interface 206 and an optional output interface 208. In case the blockchain database 107 is hosted externally to the network node 107, the network node 107 may access the blockchain database 107 via these interfaces 206, 208.

The above general embodiments will now be described in greater detail with reference to certain technical specifications (TSs) defined by the 3rd Generation Partnership Project (3GPP) for 5G communication systems. 3GPP TS 23.501 V15.4.0 (2018-12) defines architectural aspects of a 5G service based architecture (SBA). According to this SBA, network functions (NF) use service-based interactions to consume services from other NFs. The discovery of services and of NFs producing them is provided by a network repository function (NRF). Service producing NFs register, update or deregister their profiles in the NRF. Service consuming NFs discover services offered by NF producer instances by querying the NRF about NF instances offering services of a given type. NFs may subscribe and unsubscribe to changes in the status of NFs registered in the NRF. Based on such subscriptions, the NRF will notify NFs of status changes of other NFs.

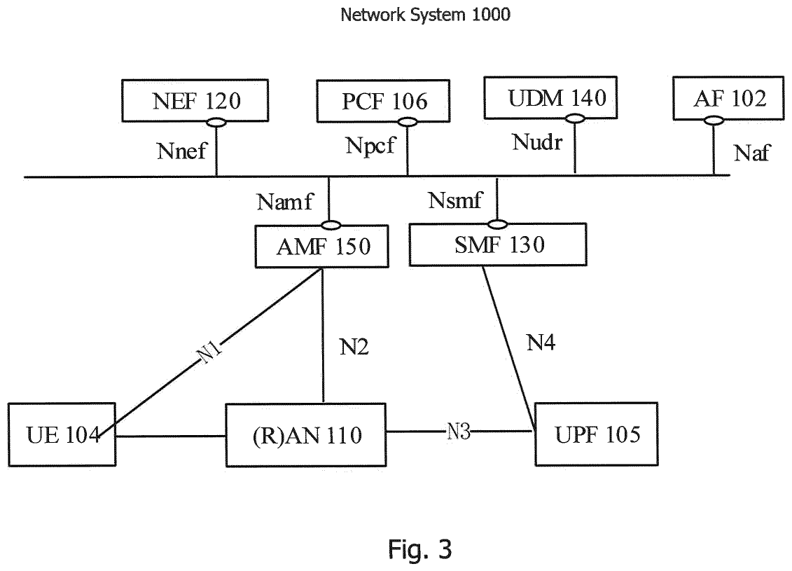

FIG. 3 depicts a portion of the 5G reference architecture as defined by 3GPP (see, e.g., Section 4.2.3 of 3GPP TS 23.501 V15.4.0). The relevant architectural core network entities (NFs) and core network interfaces for some embodiments include:
1) A User Equipment (UE) as an exemplary terminal device 104 (see FIG. 1). The UE 104 constitutes, for example, an endpoint of a voice-over-IP call or of a video or audio streaming session that stretches via the access network domain AND, such as via a (radio) access network, (R)AN 110.
2) An Application Function (AF) located outside the core network domain CND and typically implemented as, or on, an application server 102 operated by a dedicated service provisioning entity (e.g., an OTT entity). The AF 102 is configured to interact with the core network domain CND via an Naf interface. In embodiments, the AF 102 provides voice-over-IP, video streaming or audio streaming services.
3) A Network Exposure Function (NEF) 120 has an Nnef interface and supports different functionalities. Specifically, in the context of embodiments, the NEF 107A acts as an entry point into the core network domain CND for the AF 102. The AF 102 thus interacts with the core network domain CND through the NEF 120.
4) A Session Management Function (SMF) 130 has N4 and Nsmf interfaces. The SMF 130 supports procedures such as session establishment, modification and release as well as policy-related functionalities. In embodiments, the SMF 130 receives Policy and Charging Control (PCC) rules from a Policy Control Function (PCF) 106 that acts as traffic handling controller (see FIG. 1). Moreover, the SMF 130 configures a User Plane Function (UPF) 105 (i.e., the traffic handler of FIG. 1) accordingly through the N4 interface using the Packet Forwarding Control Protocol (PFCP) as follows:
   a. SMF 130 controls service traffic (i.e., packet) processing in the UPF 105 by establishing, modifying or deleting PFCP sessions and by provisioning (i.e., adding, modifying or deleting) Packet Detection Rules (PDRs) and associated traffic handling information such as Forwarding Action Rules (FARs), QoS Enforcement Rules (QERs) and/or Usage Reporting Rules (URRs) per PFCP session, whereby a PFCP session may correspond to an individual Protocol Data Unit (PDU) session or a standalone PFCP session not tied to any PDU session.
   b. Each PDR contains Packet Detection Information (PDI) for service traffic detection, specifying the traffic filters or signatures against which incoming service traffic is to be matched for reliable detection. Each PDR is associated with the following rules providing the set of instructions to apply to data packets that matching the PDI:
      i. one FAR, which contains instructions related to the processing of the packets included the service traffic, specifically forward, duplicate, drop or buffer the packet with or without notifying the Control Plane (CP) function about the arrival of a downlink packet.
      ii. zero, one or more QERs, which contain instructions related to the QoS enforcement in regard to the service traffic.
      iii. zero, one or more URRs, which contain instructions related to service traffic measurement and reporting.
5) The user plane function (UPF) 105 has an N4 interface to the SMF 130 and an N3 interface to RAN 110. The UPF 105 supports handling of service traffic on the user plane based on the rules received via the SMF 130 from the PCF 106. Specifically, in embodiments, the UPF 105 supports packet inspection in regard to the service traffic (through PDRs), and further supports the application of associated traffic handling actions such as traffic steering, QoS enforcement, charging/reporting, and so on (through FARs, QERs and URRs). As said, in the context of embodiments, the UPF 105 may take the role of the traffic handler of FIG. 1
6) The PCF 106 supports, via an Npcf interface, a unified policy framework to govern the core network domain behavior. Specifically, in embodiments, the PCF 108 provides PCC rules to SMF 130 and/or UPF 105 to detect service traffic and enforce policy and charging decisions according to the PCC rules.
7) A unified data management (UDM) entity 140 centrally stores data (e.g., subscriber information) in the core network domain 102.
8) An access and mobility management function (AMF) 150 handles access and mobility for the UE 104.

Service providers (e.g., Google) are interested in operator networks applying a specific handling for their service traffic (e.g., YouTube). For 5G systems, 3GPP has defined an exposure framework to support such traffic handling actions in a dynamic way. Specifically, there is a northbound interface between the service provider (AF 102) and the network operator (NEF 120) for provisioning (external) policies relative to the service traffic generated by the service provider, e.g., to selectively request a certain QoS level (e.g., high/low QoS) and/or to apply dedicated charging actions (e.g., sponsored data) for the service traffic generated by the service provider in a certain PDU session. Specifically, the following Application Programming Interfaces (APIs) are provided (wherein AS stands for application service):
Nnef Northbound API for “Setting up an AS session with required QoS”
Nnef Northbound API for “Changing the chargeable party at session set up or during the session”.

In the APIs above, the service traffic subject to a certain QoS and/or charging handling is detected by traffic detection information composed of packet filters such as N-tuples. For example, a 5-tuple of a particular service traffic flow (i.e., of the data packets constituting same) contains its source Internet Protocol (IP) address, its source port, its destination IP address, its destination port, and an identifier of the transport layer (i.e., layer 4) protocol, such as:
191.168.124.100/50271/181.209.179.69/80/6″
   for a data packet coming from port 50271 of IP address 1911.168.124.100, going to port 80 of IP address 181.209.179.69, using IP protocol 6, which is the Transmission Control Protocol (TCP).

The traffic detection information may, of course, take different forms and comprise different parameters. In an IP implementation, one or more of the following parameters may be used, in any suitable combination: source/destination IP address or IPv6 prefix, source/destination port number, protocol ID of the protocol above IP/Next header type, Type of Service (TOS) (IPv4)/traffic class (IPv6) and mask, flow label (IPv6), security parameter index, and so on. In an Ethernet implementation, one or more of the following parameters may be used, in any suitable combination: source/destination Medium Access Control (MAC) address (specified as address ranges), Ethertype as defined in IEEE 802.3, Customer-VLAN tag (C-TAG) and/or ServiceVLAN tag (S-TAG) VID fields as defined in IEEE 802.1Q, Customer-VLAN tag (C-TAG) and/or Service-VLAN tag (S-TAG) PCP/DEI fields as defined in IEEE 802.1Q

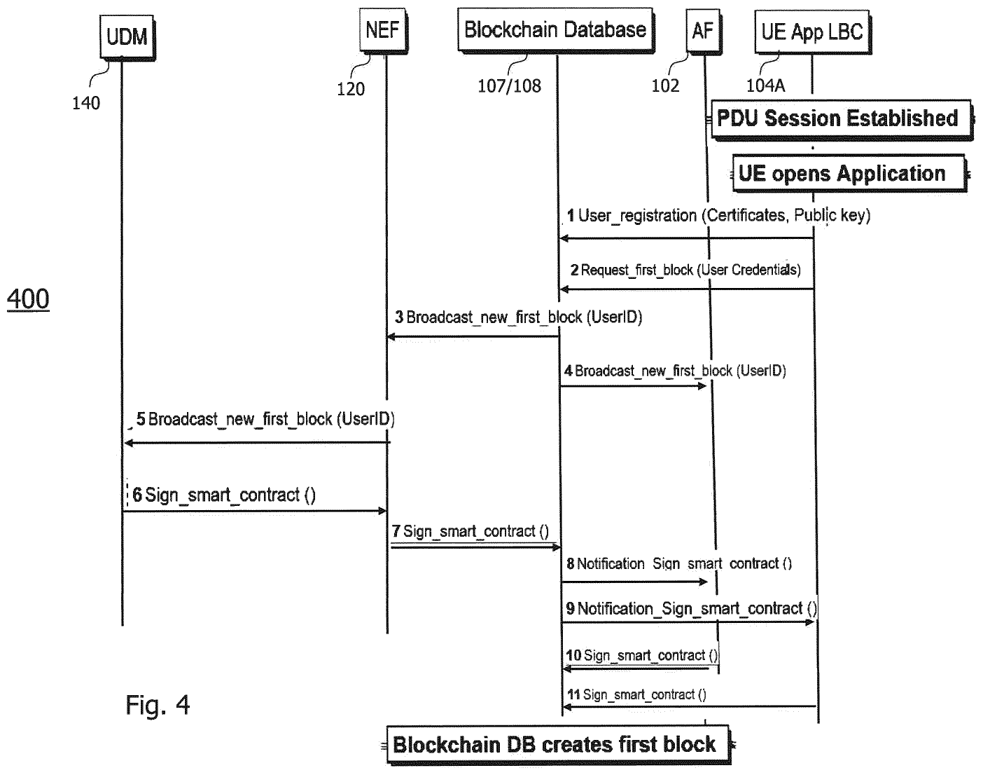

In the following description, exemplary 5G signaling embodiments will be described with reference to FIGS. 4 to 7 and the 5G entities discussed above with reference to FIG. 3.

As illustrated in FIGS. 4 to 7, a Light Blockchain Client (LBC) 104A is installed on the UE 104 and in charge of the UE-sided communication actions. This LBC 104A could be an online component that can be embedded in an app or mobile operating system of the UE 104. The LBC 104A can be deployed and updated securely by a mobile app store (e.g., Google Store or Apple Store) and could include a domain name of the network node 108 hosting the blockchain database 107 by default. This domain name cannot be altered or modified in the LBC 104A without compromising the LBC 104A (to establish security). The LBC 104A may also store or include an identifier of an associated application service (AppID) by default in order to identify the service (i.e., service provider 102) when the LBC 104A communicates with other entities (e.g., registers in the blockchain database 107).

In some implementations, the LBC 104 is configured to register in a private blockchain, to delegate the creation of data blocks under agreement of all parties involved, and to sign transactions and/or data blocks in a selective endorsement procedure. In some variants, a dedicated data block may be created for each transaction that is stored in the blockchain. In other variants, a data block may contain multiple transactions.

Still referring to FIGS. 4 to 7, the UDM 140 is registered by NEF primitives at the network node 108. The UDM 140 will act as authorized authority to approve subscriber (i.e., service consumer) registration in the blockchain database 107. The UDM 140 is also configured to participate in a selective endorsement procedure with the subscriber and the service provider to sign a “smart contract” in the blockchain database 107, as will be explained below in greater detail with reference to FIG. 4.

The PCF 106 is registered at the NEF 120 to receive blockchain notifications issued by the blockchain domain BCD (here: the network node 108). Creation of any new blockchain transaction and/or new data block will trigger a notification from the blockchain domain BCD via the NEF 120 to the PCF 106 to activate corresponding user policy (i.e., traffic handling) enforcements. The PCF 106 will forward the corresponding PDRs to the control plane (i.e., the SMF 300).

The AF 102 is registered in the NEF 120 to receive notifications from the blockchain domain BCD. Based on those notifications, the AF 102 will act correspondingly as authorized/authorizing authority in regard to the blockchain database 107 (e.g., in the context of selective endorsement procedures).

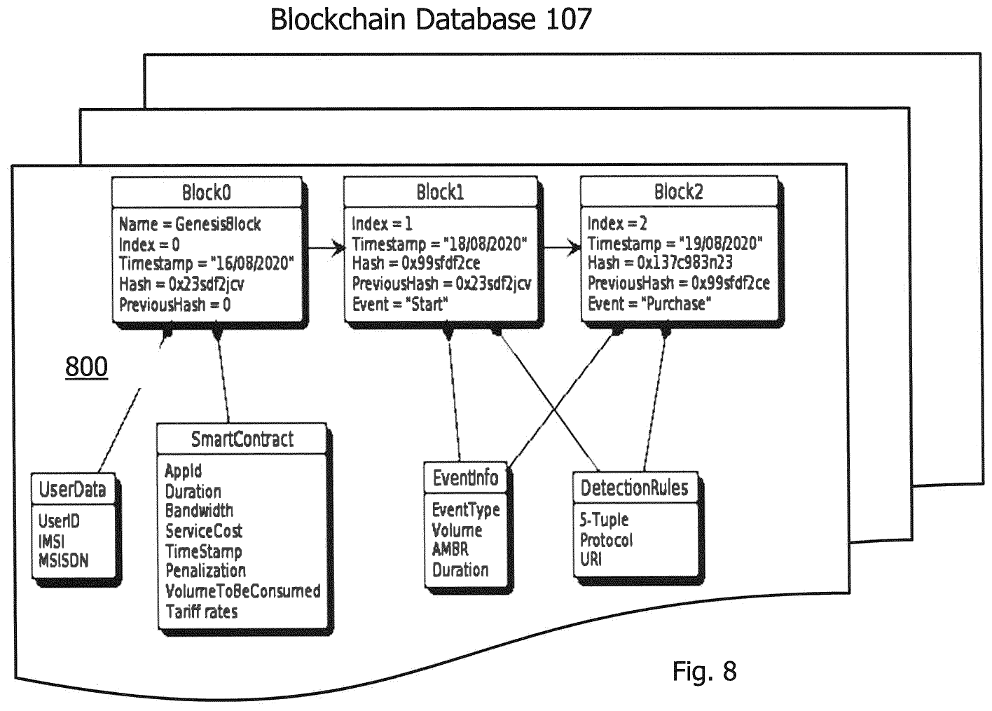

The signalling diagram of FIG. 4 pertains to the launching, or instantiation, of a new service by the LBC 104A as installed on the UE 104. In this context, a new blockchain will be created in the blockchain database 107. FIG. 8 illustrates an example of an individual blockchain 800 as created in the blockchain database 107 upon launch of a service.

As shown in FIG. 8, first data block (Block0), the so-called genesis data block, of the blockchain 800 will contain information about the service in terms of a smart contract. In the genesis data block, all information about a particular service (as identified by AppID) and about the handling of the associated service traffic in the core network domain CND will be included, optionally as part of the smart contract: service duration, service tariff/rates, traffic volume to be consumed, service costs, penalizations, bandwidth, and so on. The service costs can in certain variants be shared between network operator and service provider. As will be discussed with reference to FIG. 4 in greater detail, the smart contract will be approved (here: signed) by all parties involved upon creation of the genesis block.

As illustrated in FIG. 8, the genesis data block will also include an identifier of the subscriber and/or an identifier of the service consumer (i.e., the UE 104) operated by the subscriber. Such an identifier may take the form of a user identifier (UserID), a International Mobile Subscriber Identity (IMSI), or a Mobile Station Integrated Services Digital Network Number (MSISDN). Moreover, the genesis data block, and each further data block, will include an index, a timestamp and a hash value (typically over its whole content).

The following data blocks, such as Block1 and Block2 in FIG. 8, will be created during interaction with the service by the UE 104 and will reference the immediately preceding data block by its hash value. If the UE 104 downloads a movie or plays a online music, then a new data block will be created indicating this new event (e.g., Start” in Block1 of FIG. 8) and adding all information about this event (EventInfo in FIG. 8) and traffic detection information (DetectionRules in FIG. 8) about how to detect the encrypted service traffic associated therewith (such as IP addresses, ports, digital signatures, certificates). All this information is encrypted inside the data block and only visible to the subscriber, the network operator and the service provider.

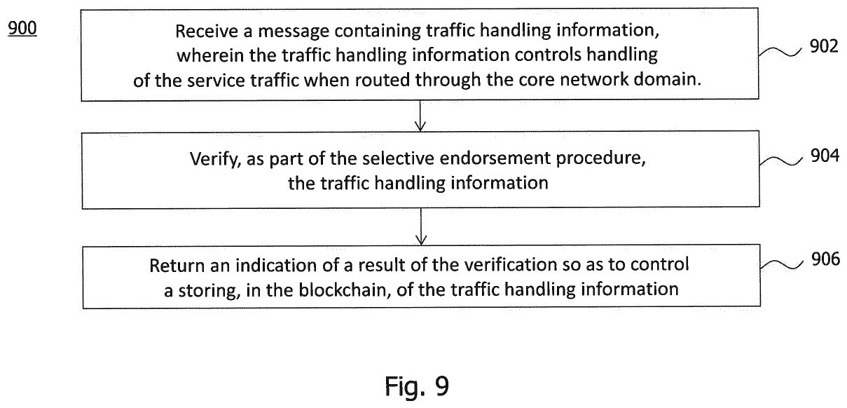

With detailed reference to the signalling diagram 400 illustrated in FIG. 4 and the flow diagram 900 of FIG. 9, generation of a first data block of a new blockchain 800 will now be described in more detail.

As shown in FIG. 4, a PDU session involving the UE 104 with its LBC 104A has previously been established. Then, an application (e.g., a so-called “app” such as a YouTube app) is opened, or launched, on the UE 104. This process will trigger the associated LBC 104A (embedded in the app or in the mobile operating system running on the UE 104) to register at the network node 108 (e.g., in the blockchain database 107) by supplying the user credentials (e.g., a user certificate) using public key-based cryptography, see step 1 in FIG. 4. The LBC 104A will not need to specifically discover the network node 108 and its blockchain database service since its domain name is already included (and updated) in the LBC software (for security reasons). The message sent in step 1 may also include AppID to identify the proper AF 102 to be notified by the network node 108.

In step 2, the LBC 104A will request the creation of the first block (genesis) of a new blockchain (see reference numeral 800 in FIG. 8). The network node 108 with the blockchain database 107 will transmit (e.g., broadcast) a notification (with an identifier associated with the UE 104, such as the UE 104) on the creation of a new data block to the remaining parties in the steps 3, 4 and 5. As such, in steps 3 and 5, the network node 108 will forward a corresponding notification, via the NEF 120, to the UDM 140. Moreover, in step 4 the network node 108 will forward a corresponding notification also to AF 102.

In step 6, the UDM 140 will compose a smart contract based, inter alia, of the subscriber details and pre-agreed contractual terms stored locally. In the present embodiment, a smart contract is a transaction protocol which is intended to automatically execute, control or document legally all the relevant events and actions according to the contractual terms. As shown in FIG. 8, this smart contract will indicate AppID, service costs/tariff, charging, penalizations, duration, maximum bitrate, etc. to subscriber/UE 104, operator and AF 102. The subscriber (UE 104/LBC 104A) and UDM 140 may have pre-defined the contractual terms. If any of these terms in the presently generated smart contract would be different from those predefined, selective endorsement will fail. Otherwise, the operator can trustfully apply the traffic handling information encoded in the smart contract to charge (service costs/tariff), prioritize, restrict (maximum bitrate), etc. service traffic in the core network domain.

Still in step 6, the UDM 106 will sign the smart contract (i.e., the information contained therein, including the traffic handling information) and sent a corresponding message to the NEF 120. The NEF 120 will then, in step 7, forward this contractual information to the network node 108 for distribution among the other parties involved (AF 102 and UE 104) for selective endorsement, see steps 8 and 9. When the NEF 120 forwards the contractual information to the network node 108, it may add confidential information only shared with UE 104 (or LBC 104A and AF 102), such as encrypted subscriber and AF public keys.

The AF 102 checks the contractual information as received in step 8 and, if it can positively be verified, signs the smart contract and returns, in step 10, a corresponding signature to the network node 108 as part of the selective endorsement procedure in regard to the smart contract.

In a similar manner, the LBC 104A running on the UE 104 receives the contractual information, including the traffic handling information such as the maximum bitrate, in step 9 (see also step 902 of the flow diagram 900 of FIG. 9). It then verifies, as part of the selective endorsement procedure, the traffic handling information, for example based on pre-agreed contractual terms (see also step 904 of the flow diagram 900 of FIG. 9). In case the contractual information, including the traffic handling information, can positively be verified, the contractual information is signed by the UE 104 and the signature is returned, in step 11, to the network node 108.

Once positive verification results have been received in steps 10 and 11, the selective endorsement procedure is found to be successful and the network node 108 creates the first data block (block0, genesis) including the smart contract (with the traffic handling information) and the associated information on the subscriber and/or on UE 104 (see FIG. 8, data structures SmartContract and UserData).

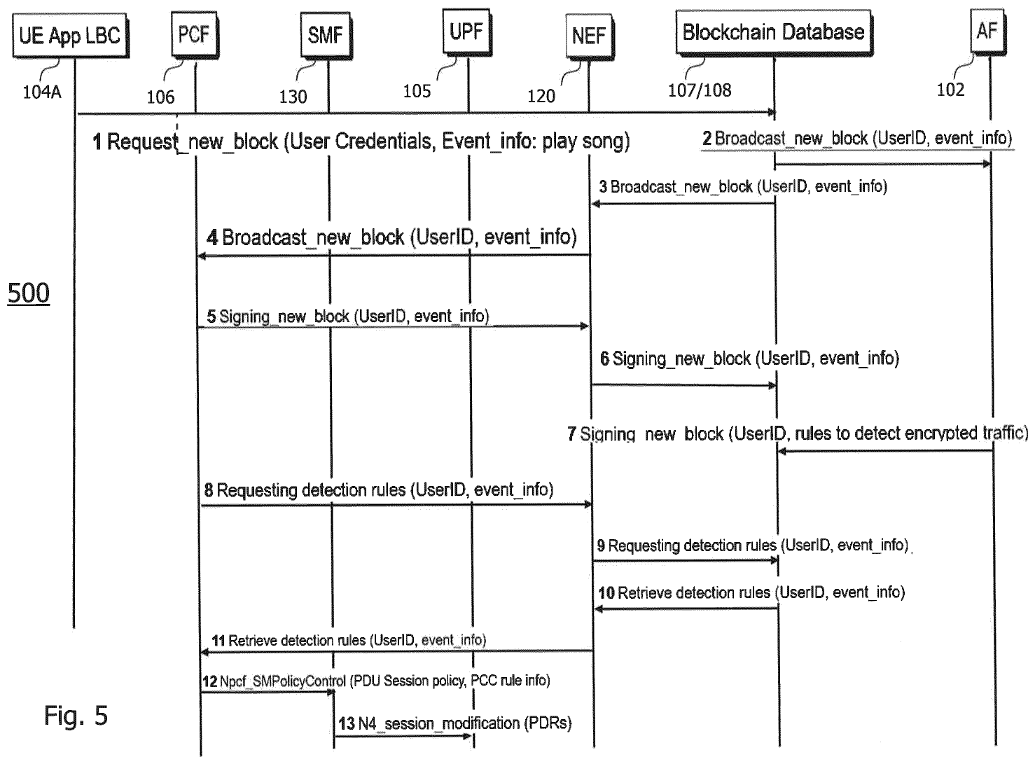

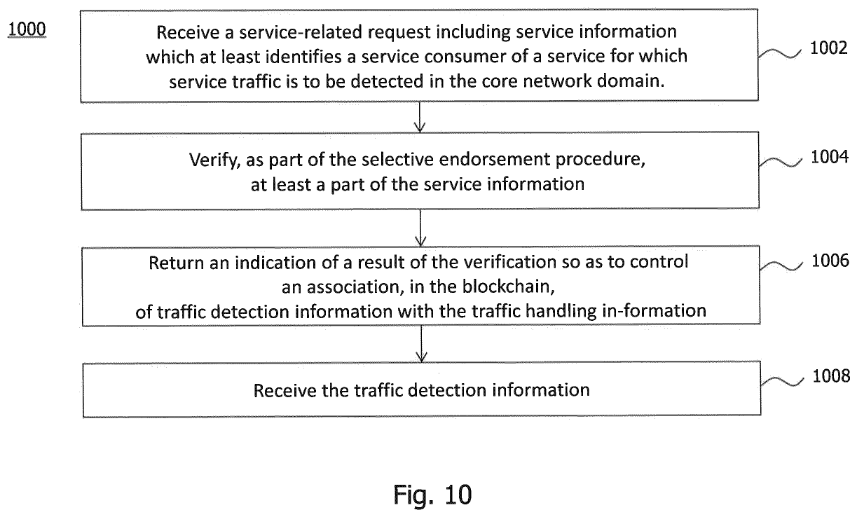

Referring now to the signalling diagram 500 of FIG. 5 and the flow diagrams 1000 to 1200 of FIGS. 10 to 12, it is assumed that in a next step, the UE 104, via the LBC 104A, actually starts the service, for example plays a movie, song or browses through an AF portal. This event of event type “Start” will create a further (second) data block in the blockchain 800 (Block1, see FIG. 8).

Upon service start (e.g., upon a user activating a start button on a touchscreen of the terminal device 1049), LBC 104A will transmit a service-related request that triggers the network node 108 to create a new data block that is to be added to Block0 (genesis) of the blockchain 800, see step 1 of FIG. 5. The new data block will include dedicated event information (e.g., event type “Start” or, more detailed, “play a song”) and associated traffic detection information for the core network domain CND.

For the purpose of selective endorsement in regard to the data block that is to be permanently associated with (i.e., appended to) the preceding data block, the network node 108 transmits (e.g., broadcasts) a corresponding notification to AF 102 in step 1 and to NEF 120 in step 3. The notification forwards certain service information, such as an indication of the event type and of the subscriber and/or UE 104 involved. In step 4, the NEF 120 will forward the notification towards PCF 106 (see also step 1002 of the flow diagram 1000 of FIG. 10). The PCF 106 then verifies the new event, and if the selective endorsement is locally successful (e.g., because the event is permitted in view of prevailing constraints that may be defined in the smart contract or otherwise), and signs the corresponding information so as to accept this new service event (see also step 1004 of the flow diagram 1000 of FIG. 10). Moreover, the PCF 106 sends a corresponding message in step 5 to the NEF 120 (see also step 1006 of the flow diagram 1000 of FIG. 10), and the NEF 120 will forward the message to the network node 108 in step 6.

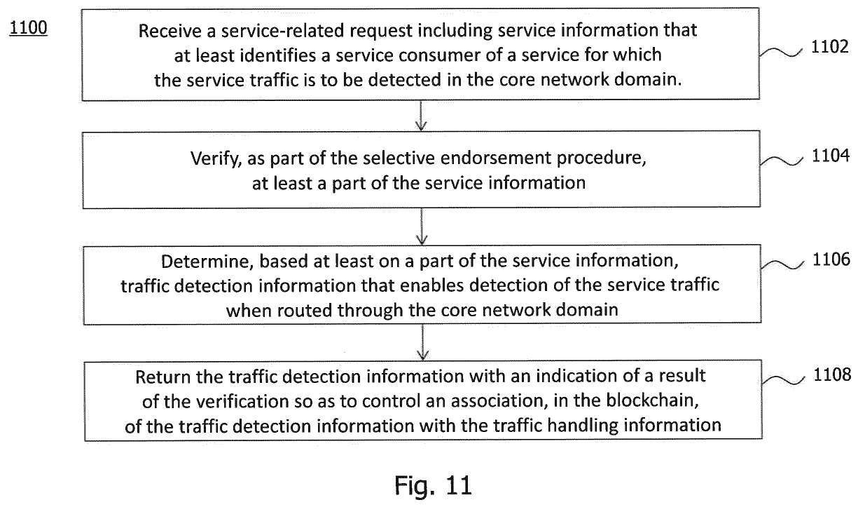

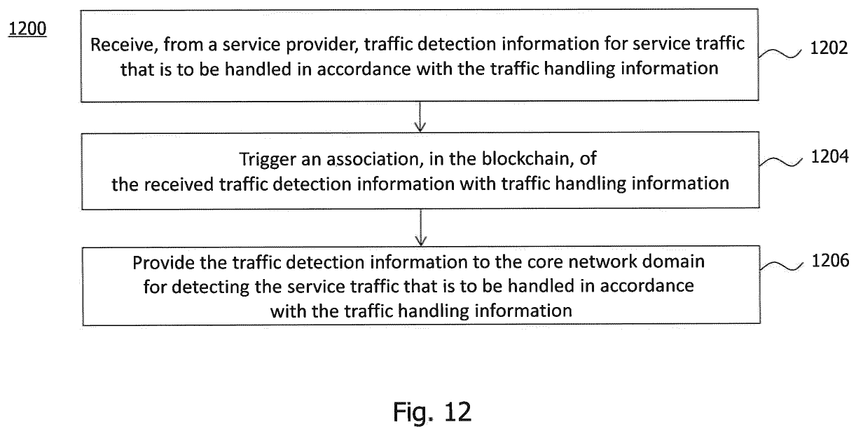

The AF 102 also verifies the new event and subscriber and/or UE identifier as received from the network node 108 (see also steps 1102 and 1104 of the flow diagram 1100 of FIG. 11), and if the selective endorsement is locally successful (e.g., because the event is permitted in view of prevailing constraints that may be defined in the smart contract or otherwise), determines the traffic detection information applicable to the upcoming (possibly encrypted) service traffic, such as dedicated detection rules (see also step 1106 of the flow diagram 1100 of FIG. 11). The AF 102 then signs the service event and the corresponding traffic detection information, and it returns the information and the associated signature in step 7 to the network node 108 (see also step 1108 of the flow diagram 1100 of FIG. 11 and step 1202 of the flow diagram 1200 of FIG. 12). The traffic detection information, or rules, may univocally be defined and may be indicative of one or more of at least one packet flow (e.g., via packet filter(s) defined as N-tuple(s) for IP, non-IP or Ethernet traffic), URI, domain name, SNI and/or DNS query name, and transport layer protocol. As part of this information, new policies can be defined under smart contract requirements previously defined in the first data block. According to conditions defined in the smart contract, new detection rules could be added. As an example, a subscriber can have different services/tariff rates/bandwidth limits depending on different periods of time (or other conditions), and so different detection rules could be delivered according to different periods of time (or other conditions).

Once the selective endorsement procedure was found by the network node 108 to have been successful based on the responses received from the NEF 120 in step 6 and from the AF 102 in step 7, a new data block (here: Block1) is permanently associated with (i.e., appended to) the preceding data block (here: Block0) of the blockchain 800 of FIG. 8. As such, the traffic handling information (as defined in the smart contract in Block0) is permanently and trustfully associated with the traffic detection information (as defined in Block1), see step 1204 of the flow diagram 1200 of FIG. 12

At some point in time, the PCF 106 will request the traffic detection information as previously defined by the AF 102. To this end, it sends a request message to the NEF 120 in step 8. The NEF 120 will forward the corresponding request to the network node 108 in step 9. The network node 108 then retrieves (e.g., from the blockchain 800 or a local buffer) the traffic detection information previously received from the AF 102 and returns the retrieved traffic detection information to the NEF 120 in step (see step 1206 of the flow diagram 1200 of FIG. 12.

The NEF 120 forwards the traffic detection information to the PCF 106 in step 11 (see also step 1008 of the flow diagram 1000 of FIG. 10). The PCF 106 then transforms the received traffic detection information in a set of new policies (e.g., as a PDU session policy and/or PCC rules and/or PDRs) and forwards same to the SMF 130 in step 12. In step 13, the SMF 130 sends those policies (e.g., as PDRs) to the UPF 105. From that point onward, the UPF 105 is configured to monitor the service traffic on the user plane by applying, for example, the N-tuple(s) provisioned by SMF 130 in the PDRs. The UPF 105, via the SMF 130, may confirm that service traffic corresponding to the traffic detection information has been detected.

Moreover, the UPF 105 may also report corresponding measurements (e.g., traffic volume(s)) to the SMF 130. The SMF 130, or any other core network node, may then control application of a corresponding traffic handling action (e.g., charging, bandwidth control, etc.) as defined in the traffic handling information associated with the traffic detection information in the blockchain 800, thus closing the circle of trust.

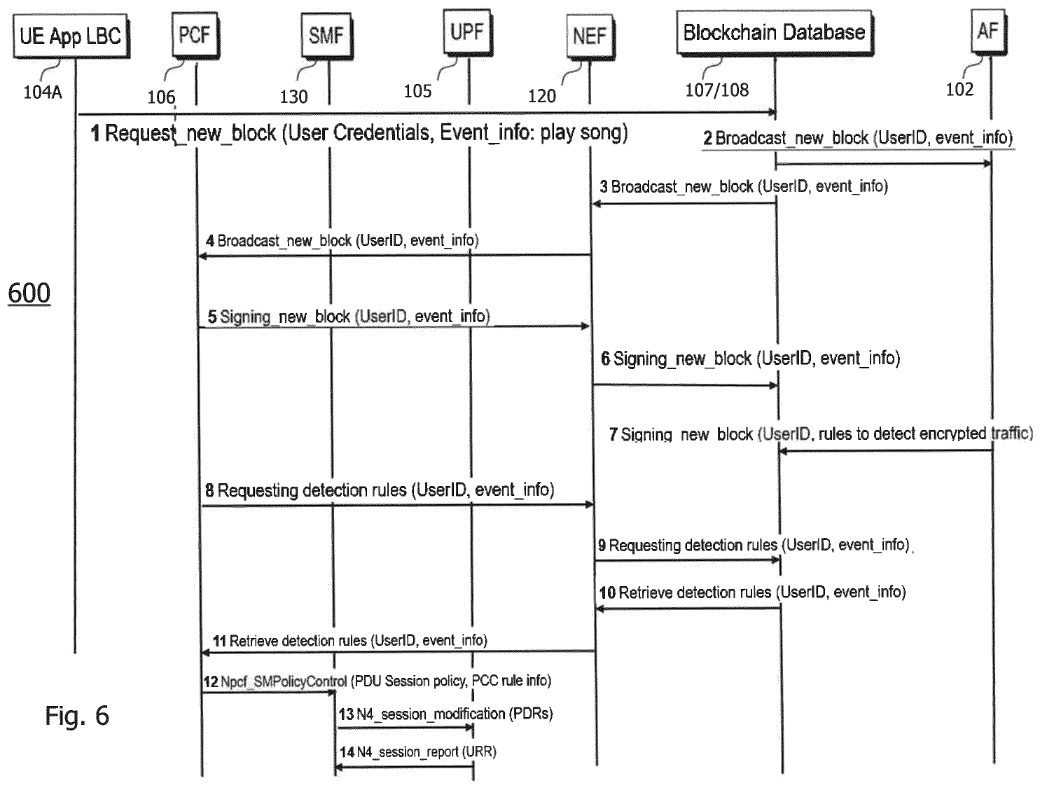

The signalling scenario of FIG. 6 is very similar to that of FIG. 5 except that in a further step 14, the UPF 105 will start a new detection/inspection and report the previously measured or otherwise determined volume/session details to the SMF 130. This reporting is important when the service or a portion thereof ends (and can, e.g., be billed as a completed purchase) and, thus, needs to be reported to and logged by the network node 108. This event will create a new third data block (see Block2 in FIG. 8).

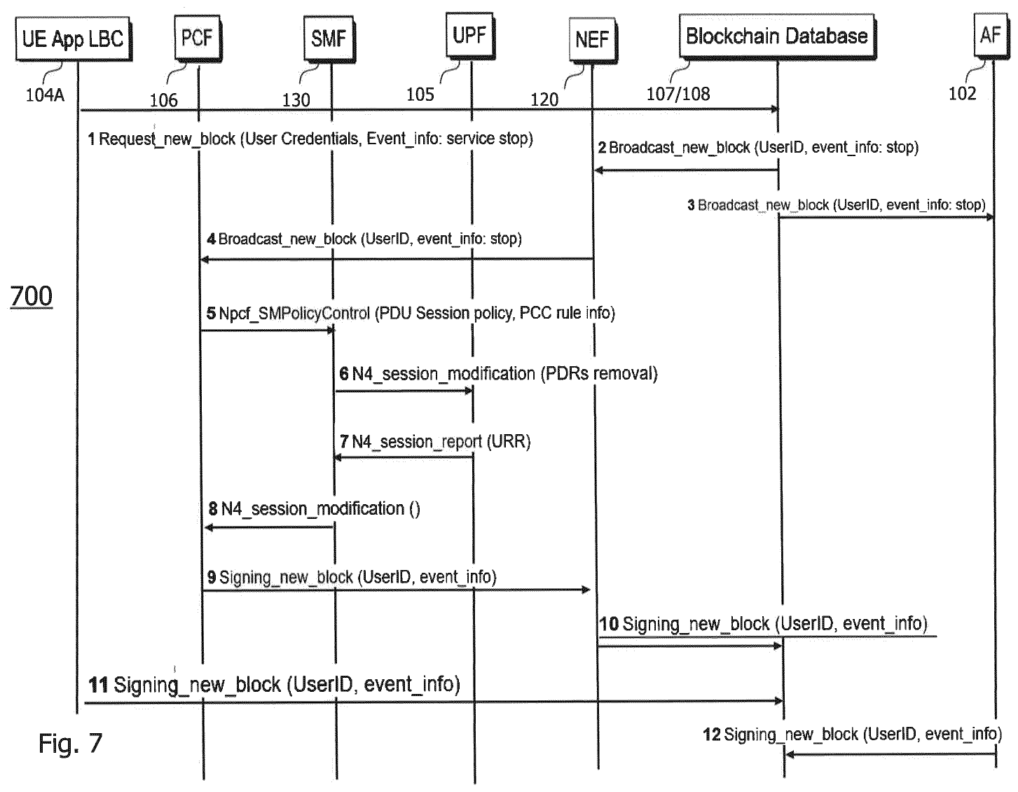

The signalling scenario of FIG. 7 illustrates the process when the LBC 104A logs out from a service platform or the service has ended (e.g., a movie, song or call is over).

While not illustrated in FIG. 8, a further (and potentially final) data block will be added to the blockchain 800. In this regard, the LBC 104A, in step 1, requests the creation of this new block (of event type “service stop”) from the network node 108. The network node 108 transmits a corresponding event notification to the NEF 120 in step 2 and the AF 102 in step 3. The notification is forwarded by the NEF 120 to the PCF 106 in order to trigger stopping of service monitoring and reporting of the volume consumed, see step 4. The PCF 106, in step 5, notifies the SMF 103 of the service stop via a NPCF_SMPolicyControl directive. Then, in step 6, the SMF 130 forwards instructions regarding PDR removal to the UPF 105 in order to abort service detection in the UPF 105.

The UPF 105, in step 7, deletes all PDRs associated to this service and reports, for example, the accumulated volume consumed and(or other session parameters to the SMF 130 (URR). The SMF 130 will report this information to the PCF 106 (via the N4 interface). For purposes of selective endorsement, the PCF 106 creates a signature for the (potentially) last data block of this blockchain 800 over the associated service information (such as one or more of event type “service stop”, volume consumed, costs charged, etc.) and forwards the information and the signature in step 9 to the NEF 120, which forwards it in step 10 to the network node 108. Also the LBC 104A, for purposes of selective endorsement, creates a signature for the new block over the relevant information (here: service type and, optionally, an associated identifier) and transmits a corresponding message to the network node 108 in step 11. In step 12, a similar message is received by the network node 108 from the AF 102. Having achieved consensus among all participants, the network node 108 will be permanently appended as a corresponding data block to the blockchain.

It will, in this context, be appreciated, that the order in which steps 10, 11, 12 are performed does not matter. The same applies to the selective endorsement procedures discussed above with reference to FIGS. 4 to 6. Moreover, it will be appreciated that in certain variants, more than one blockchain transaction (e.g., service event) may be stored in a single data block. In some variants, the various blockchains in the blockchain database 107, such as the blockchain 800, may have dedicated blockchain identifiers. Those blockchain identifiers may, in some variants, be included in the messages sent by and received at the network node 108.

In a 4G context, the signalling will be similar as discussed above. The PCF 106 would be realized by a Policy and Charging Rules Function (PCRF), the UPF 105 and the SMF 130 by a Packet Data Network Gateway (PGW), and the UDM 140 by a Home Subscriber Server (HSS), possibly paired with a User Data Repository (UDR).

As has become apparent from the above description of exemplary embodiments, the technique presented herein allows detecting and classifying encrypted service traffic so as to enforce dedicated service traffic policies (such as charging or QoS control) under agreement of all parties engaged: network operator, subscriber (service consumer) and service provider. One advantage is the agreement and acknowledgement of the subscriber for any service action and cost. The subscriber can check any volume consumed and any charges in any moment and accept or reject them. The subscriber can follow and verify any other information related to a dedicated service (duration, service type chosen: movies, files, calls, etc.).

The costs of service can be shared as agreed with the operator in the moment that the service is going to be launched. These costs can be approved by the subscriber by signing a smart contract. Traffic encryption is not compromised since the network operator need not inspect traffic content for proper service traffic detection. The network operator need only detect the service traffic using abstract parameters and may enforce traffic handling without understanding the content/protocol of the service.

The blockchain approach allows a check that all three parties involved agree with the service provided: charging, time, cost, etc. A smart contract can compile all this information, and blockchain techniques will ensure that none can alter the smart contract: the smart contract is always available and inalterable.

Network operators can apply policies to any service without knowing any detail or protocol of the service. If a service changes protocol/servers/ports in the future, the operator does not need to be informed since the approach suggested herein ensures that the service will be always trustfully identifiable thanks to interaction of the service provider in the blockchain. This fact is especially important when all traffic is encrypted, so that it is not possible to identify what is being delivered inside the data packets routed through the core network domain.

It will be appreciated that the present disclosure has been described with reference to exemplary embodiments that may be varied in many aspects. As such, the present invention is only limited by the claims that follow.

1-44. (canceled)

45. A method of configuring a core network domain of a wireless communication network for detection of service traffic that is to be trustfully handled in accordance with traffic handling information stored in a blockchain, the method comprising:
receiving, from a service provider, traffic detection information for service traffic that is to be handled in accordance with the traffic handling information;
triggering an association, in the blockchain, of the received traffic detection information with the traffic handling information; and
providing the traffic detection information to the core network domain for detecting the service traffic that is to be handled in accordance with the traffic handling information.

46. The method of claim 45, wherein
the traffic detection information is received responsive to a service-related request having been triggered by a service consumer.

47. The method of claim 46, comprising
receiving the service-related request from the service consumer; and
triggering storing of the service-related request, or of information contained therein, as a dedicated event in the blockchain.

48. The method of claim 47, comprising
forwarding the service-related request, or information contained therein, to the service provider; wherein
the traffic detection information is received as a response to the forwarding of the service-related request, or of the information contained therein.

49. The method of claim 47, comprising
forwarding the service-related request, or information contained therein, to the core network domain; and
receiving, as a response from the core network domain, a detection information request; wherein
the traffic detection information is provided to the core network domain responsive to the detection information request.

50. The method of claim 48, wherein
forwarding of the service-related request to the service provider and the core network domain, as well as the responses from the service provider and the core network domain, belong to a selective endorsement procedure; and wherein
the received traffic detection information is selectively permanently associated in the blockchain with the traffic handling information if the selective endorsement procedure was successful.

51. The method of claim 45, wherein
triggering, in the blockchain, an association of the received traffic detection information with the traffic handling information comprises triggering storing of the traffic detection information in a data block of the blockchain, wherein the traffic handling information is stored in the same or another data block of the blockchain.

52. The method of claim 45, comprising
detecting a particular event related to a service associated with the service traffic; and
triggering, for each detected event, creation at least one of a dedicated transaction and a dedicated data block in the blockchain.

53. The method of claim 52, comprising
triggering a selective endorsement procedure for each dedicated transaction or each dedicated data block.

54. The method of claim 53, wherein
triggering the selective endorsement procedure for a given transaction or a given data block comprises sending transaction information to be stored in the blockchain to two or more members of a selective endorsement group comprising the service provider, a service consumer, and an operator of the mobile communication network.

55. The method claim 54, wherein
the particular event is selected from a set of event types comprising: service creation, service start, service termination, service modification.

56. The method of claim 45, wherein
the blockchain is a private blockchain among the service provider, a service consumer, and an operator of the wireless communication network.

57. The method of claim 45, wherein
the traffic handling information relates to one or more of: Quality-of-Service, QoS, handling of the service traffic; billing of the service traffic; a predefined service traffic volume; penalization handling; service duration.

58. The method of claim 45, wherein
the traffic handling information is encoded in the blockchain in the form of a smart contract.

59. The method of claim 45, wherein
the traffic to be detected in the core network domain is end-to-end encrypted between the service provider and a service consumer.

60. The method of claim 45, wherein
the traffic detection information identifies at least one packet flow transporting the service traffic.

61. The method of claim 60, wherein
the traffic detection information comprises one or more of the following:
information permitting identification of a packet flow transporting the service traffic;
a universal resource identifier, URI;
one or more of a domain name, a Domain Name System, DNS, query name, and a Service Name Indication, SNI, query name; and
a transport layer protocol.

62. The method of claim 45,
wherein the method is performed outside the core network domain.

63. A device for configuring a core network domain of a wireless communication network for detection of service traffic that is to be trustfully handled in accordance with traffic handling information stored in a blockchain, the device being configured to:
receive, from a service provider, traffic detection information for service traffic that is to be handled in accordance with the traffic handling information;
trigger an association, in the blockchain, of the received traffic detection information with the traffic handling information; and
provide the traffic detection information to the core network domain for detecting the service traffic that is to be handled in accordance with the traffic handling information.

64. A non-transitory, computer-readable medium containing instructions stored thereon operative to cause computational circuitry in a device for configuring a core network domain of a wireless communication network for detection of service traffic that is to be trustfully handled in accordance with traffic handling information stored in a blockchain to
receive, from a service provider, traffic detection information for service traffic that is to be handled in accordance with the traffic handling information;
trigger an association, in the blockchain, of the received traffic detection information with the traffic handling information; and
provide the traffic detection information to the core network domain for detecting the service traffic that is to be handled in accordance with the traffic handling information.
